(19) United States
(12) Patent Application Publication
(10) Pub. No.: US 2024/0164395 A1
(43) Pub. Date: May 23, 2024

(54) EDIBLE SPRAY OR COATING COMPOSITION FOR EXTENDING LIFE OF PERISHABLE GOODS AND METHODS OF PRODUCTION AND USE THEREOF

(71) Applicant: Ryp Labs, Inc., Bothell, WA (US)

(72) Inventors: Ahmed SOLIMAN, Kirkland, WA (US); Nuria VIVES, Leuven (BE); Steven HULTENG, Mukilteo, WA (US); Patrick VAN DIJCK, Scherpenheuvel-Zichem (BE); Michelle HOLTAPPELS, Diest (BE); Ozgur YILDIRIM, Bellevue, WA (US); Benjamin Grady JONES, Issaquah, WA (US)

(73) Assignee: Ryp Labs, Inc., Bothell, WA (US)

(21) Appl. No.: 18/551,144

(22) PCT Filed: Apr. 13, 2022
(86) PCT No.: PCT/US2022/024674

§ 371 Date: Sep. 18, 2023

Related U.S. Application Data
(60) Provisional application No. 63/174,392, filed on Apr. 13, 2021.

(51) Int. Cl. A23B 7/16; A23B 7/155

(52) U.S. Cl. CPC A23B 7/16; A23B 7/155

(57) ABSTRACT

Edible spray or coating compositions are disclosed for use in the reduction in post-harvest spoilage of fruits, vegetables, and plants by utilizing at least one of various functional agents in combination with at least one carrier or film-forming material. The at least one shelf-life extending agent may be at least one volatile compound, at least one plant immune-stimulatory compound, at least one non-volatile compound, at least one microorganism, and/or at least one ethylene actor compound. Assemblies containing the edible spray or coating compositions, as well as methods of producing and using the edible spray or coating compositions, are also disclosed.

### CROSS REFERENCE TO RELATED APPLICATIONS/INCORPORATION BY REFERENCE STATEMENT

This application claims benefit under 35 USC § 119(e) of U.S. Provisional Application No. 63/174,392, filed Apr. 13, 2021. The entire contents of the above-referenced patent application(s) are hereby expressly incorporated herein by reference.

### TECHNICAL FIELD

The presently disclosed and/or claimed inventive concept(s) relates generally to the extension of the post-harvest life of perishable goods; i.e., of fruits, vegetables, plants, and other perishable goods, by utilizing various functional agents in combination with a carrier. It is known to those of ordinary skill in the art that the carrier may also be a film-forming material. More specifically, but not by way of limitation, the presently disclosed and/or claimed inventive concept(s) discloses to the application of an edible spray or coating that may comprise at least one shelf-life extending agent, wherein the at least one shelf-life extending agent is selected from a group consisting of an antimicrobial compound, a bio-control agent, an immunostimulatory compound, an ethylene inhibitor, an antioxidant, and combinations thereof, in combination with a carrier in the extension of the post-harvest life perishable goods.

### BACKGROUND

Perishable goods such as plants and fresh produce are highly susceptible to degradation and decomposition (i.e., spoilage) when exposed to the environment. The degradation of the agricultural products can occur, for example, via abiotic means as a result of evaporative moisture loss from an external surface of the agricultural products to the atmosphere, oxidation by oxygen that diffuses into the agricultural products from the environment, mechanical damage to the surface, and/or light-induced degradation (i.e., photodegradation). Furthermore, biotic stressors, such as bacteria, fungi, viruses, and/or pests, can infest and decompose the perishable goods.

Various compounds are known to delay the spoilage of perishable goods by targeting various spoilage mechanisms, inhibiting the growth and spread of spoilage-causing organisms, stimulating the natural defense mechanisms of plants making them more resistant to attacks by pathogens. For example, Patent Publication WO 2019/108241A1 generally discloses an anti-spoiling, freshness-preserving composition for extending the shelf-life of at least one produce item.

In another example, U.S. Patent Publication US 20180368427A1 generally discloses compositions and methods of reducing spoilage in a produce item by reducing the rate of water or mass loss, thereby resulting in high quality produce with lower rates of spoilage. The disclosure provides coatings and methods of coating produce to prevent moisture loss from produce during storage and shipment of the produce. This in turn allows the produce to be shipped and stored at lower relative humidity (e.g., lower than industry standards for shipment and storage, or lower than about 90% relative humidity), which can help delay the growth of biotic stressors such as fungi, bacteria, viruses, and/or pests.

However, the aforementioned compositions and methods target the individual factors that affect the spoilage of at least one produce item, leaving other factors unaddressed. As such, a need exists in the industry for compositions that include at least one shelf-life extending agent in combination with a carrier or film-forming material to reduce the spoilage of at least one produce item by concurrently addressing multiple factors.

### BRIEF DESCRIPTION OF THE DRAWINGS

FIG. 1 graphically depicts the effects of application of one-non-limiting embodiment of a coating composition constructed in accordance with the present disclosure to produce stored at a refrigerated temperature over a period of 24 days.

FIG. 2 contains photographs depicting the results at the end of the method shown in FIG. 1. The photograph on the left depicts untreated produce, while the photograph on the right depicts produce that was treated with the composition in accordance with the present disclosure.

### DETAILED DESCRIPTION

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those skilled in the art that variations may be applied to the articles and/or methods and in the steps or in the sequence of steps of the method described herein without departing from the concept, spirit, and scope of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one”, but it is also consistent with the meaning of “one or more”, “at least one”, and “one or more than one”. The use of the term “or” is used to mean “and/or” unless explicitly indicated to refer to alternatives only if the alternatives are mutually exclusive, although the disclosure supports a definition that refers to only alternatives “and/or”. Throughout this application, the term “about” is used to indicate that a value includes the inherent variation of error for the quantifying device, the method being employed to determine the value, or the variation that exists among the study subjects. For example, but not by way of limitation, when the term “about” is utilized, the designation value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

The presently disclosed and/or claimed inventive concept(s) relates generally to an edible spray or coating composition for extending the life of at least one produce item comprising at least one shelf-life extending agent, a carrier or film-forming material, and optionally a solvent. The shelf-life extending agent may be selected from a group consisting of an antimicrobial compound, a bio-control agent, an immunostimulatory compound, an ethylene inhibitor, an antioxidant, and combinations thereof. The carrier or the film-forming material may be chosen from a group consisting of an emulsifier, a protein, a wax, a polysaccharide, a gum, a carbohydrate, and combinations thereof.

When the composition is an edible spray composition, the composition may further include a solvent or thinning agent. The solvent or thinning agent may be chosen form a group consisting of alcohol, oil, and water.

The at least one produce item may include, but is not limited to fruit, vegetable, legume, tuber, plants, or the like. The edible spray or coating composition may be applied to the exterior surface of the at least one produce item pre-harvest or post-harvest.

The shelf-life extending agent may be selected from a group consisting of at least one antimicrobial compound, at least one bio-control agent, at least one immunostimulatory compound, at least one ethylene inhibitor, at least one antioxidant, and combinations thereof. In some non-limiting implementations, the shelf-life extending agent may be an antimicrobial compound (such as, but not limited to, an antifungal compound) that comprises at least one essential oil. The at least one essential oil may be selected from a group consisting of hexanal, hexenal, cuminal, cuninaldehyde, perillal, carvacrol, thymol, citral, citronellal, citronellol, menthol, cinnamal, terpinene-4-ol, terpineol, carvone, menthone, pulegone, eugenol, linalool, nerol, neral, geraniol, geranial, hexanol, hexenol, octanal, octanol, octenol, octenal, nonanol, nonanal, nonenol, nonenal, nonadienol, nonadienal, farnesol, limonene, pinene, myrcene, ocimene, terpinene, anethole, borneol, myrtenal, myrtenol, fenchol, piperonal, pulegol, carveol, decanal, decanol, decenal, decenol, decadienol, decadienal, cymene, menthane, phellandrene, phellandral, camphene, camphor, fenchone, cuminol, o-anisal, p-anisal, raspberry ketone, ionone, damescenone, lilac aldehyde, fenchene, bornylene, perillol, piperitone, geranial, nerolidol, rhodinol, furanones, and combinations thereof. In one non-limiting implementation, the essential oil may be a complex mixture of different organic molecules, also known as essential oil components (EOCs); non-limiting examples thereof include monoterpenes, diterpenes, sesquiterpenes, or their oxygenated forms, terpenoids, alcohols, esters, aldehydes, ketones, phenols, thiols, alkaloids, and combinations thereof. In one non-limiting implementation, the essential oil compound may be distilled or extracted from at least one plant. For example, but in no way limiting, the essential oil compound distilled or extracted from at least one plant may be thyme oil, tea tree oil, citrus oil, combinations thereof, and the like. The chemical composition of the essential oil may vary depending on time of day, the month, or season the essential oil is harvested. In other non-limiting implementations, the antimicrobial compound comprises a non-essential oil selected from a group consisting of citric acid, citrate, sodium citrate, capsaicin, acetic acid, acetate, sorbic acid, benzoic acid, propionic acid, sulfite, sodium sulfite, sorbate, potassium sorbate, benzoate, sodium benzoate, propionate, calcium propionate, nicin, curcumin, coumarin, phenylalaine, vanillin, nootkatone, natamycin, and combinations thereof. An example of an alkaloid may include, but are not limited to, capsaicin. In some non-limiting implementations, the antimicrobial compound may be a synthetic oil. A non-limiting example of the synthetic oil may be chosen from a group consisting of menthol, eucalyptol, and combinations thereof. Synthetic oils may have at least one of EOC of a particular essential oil. Further, synthetic oils the chemical composition may vary from batch to batch. The antimicrobial compound may suppress the growth, spread, and/or proliferation of at least one microorganism that may cause spoilage of the at least one produce item. The at least one microorganism may be a fungus, bacteria, mold, yeast, or the like.

In one non-limiting implementation, the edible spray or coating composition may include at least a first antimicrobial compound and a second antimicrobial compound. The two or more antimicrobial compounds may create a synergistic effect of an extended life of the at least one produce item as compared to an edible spray or coating composition comprising one antimicrobial compound. The two or more antimicrobial compounds of the edible spray or coating composition may act in concert or may act independently of one another. In some non-limiting implementations, negative interactive results as to a first application of the edible spray or coating composition may be tolerated in order to gain positive interactive results due to a second application of the edible spray or coating composition.

In other non-limiting implementations, the shelf-life extending agent may be at least one bio-control agent. The bio-control agent may be selected from a group consisting of Bacillus, Pseudomonas, Cryptococcus, Clonostachys, and combinations thereof. In one non-limiting implementation, the bio-control agent may comprise at least one microorganism. The edible spray or coating composition may have the bio-control agent to achieve the desired biological outcome of competing with, or otherwise suppressing, spoilage-causing organisms. The bio-control agent may be present at any concentration that allows the edible spray or coating composition to function in accordance with the present disclosure. In one non-limiting embodiment, the concentration of the bio-control agent present in the edible spray or coating composition may be up to about 1×10⁹ cfu/g.

In one non-limiting implementation, the bio-control agent is a microorganism, and the microorganism may be disposed in the composition in a dormant or active state. In one non-limiting implementation, the at least one microorganism may be in a dried powder form. By way of an example, but in no way limiting, the at least one microorganism in the dormant, dried powder form may be in a lyophilized powder. In some non-limiting implementation, the carrier or film-forming material may have essential nutrients to promote the growth of the at least one microorganism. The at least one microorganism may be (for example, but not by way of limitation) a bacterium, a fungus, or a virus.

In another implementation, when the condition of the skin of the at least one produce item begins to change, the at least one bio-control agent maybe converted from a dormant state to an active state. The change in the condition of the skin of the at least one produce item include, but are not limited to, bruising of the surface, an increase in moisture on the surface of the at least one produce item, tear in the surface of the at least one produce item, an increase in pathogenic organisms on the surface of the at least one produce item, and combinations thereof. An increase in pathogenic organisms on the surface of the produce item may result in the growth of the bio-control agent due to the degradation of the produce item becoming a source of nutrients for the bio-control agent. The degradation of the surface of the produce item may result in an increased presence of water on the surface of the produce item, as well as provide a source of nutrients for the bio-control agent present in the edible spray or coating composition. The conversion of the bio-control agent from the dormant state to the active state while present in the edible spray or coating composition may suppress the presence of at least one pathogen by controlling the spread and growth of the pathogen by the bio-control agent in a negative feedback loop.

In one non-limiting implementation, the presently disclosed and/or claimed inventive concept(s) may be the edible spray or coating composition comprising the carrier or film-forming material, an antimicrobial compound, and the biocontrol agent to achieve a desired biological outcome. The edible spray or coating composition comprising the carrier or film-forming material, an antimicrobial compound, and the biocontrol agent may create a synergistic effect of an increased extension of life of the at least one produce item loss compared to the extension of life of the at least one produce item having the edible spray or coating composition comprising only the carrier or film-forming material or the antimicrobial compound or the biocontrol agent applied individually to the at least one produce item.

In other non-limiting implementations, the shelf-life extending agent may be at least one immunostimulatory compound. The immunostimulatory compound may be chosen from a group consisting of methyl jasmonate, methyl salicylate, methyl cinnamate, beta-aminobutyric acid (BABA), phytoanticipines, biochar, acibenzolar-S-methyl, thiamine, jasmonic acid, salicylic acid, cinnamic acid, phytoalexins, pinene, chitosan, and combinations thereof. The immunostimulatory compound refers to a compound that does not directly affect a diseased organism, nor alter the DNA of at least one produce item. The immunostimulatory compound, activates a natural defense mechanism in the at least one produce item. It is understood to those of ordinary skill in the art that the term immunostimulatory stimulatory compound may also be known as a “plant activator.” The concentration of the immunostimulatory compound in the edible spray or coating composition may be in a range of about 0.1% to about 20% by weight.

In one non-limiting implementation, the presently disclosed and/or claimed inventive concept(s) may be the edible spray or coating composition comprising the carrier or film-forming material, at least one antimicrobial compound, and at least one immunostimulatory compound. For example, the edible spray or coating composition comprising at least one antimicrobial compound may suppress the growth and spread of a first fungus on at least one produce item, and the immunostimulatory compound may activate the natural defense of the at least one produce item against the first fungus, thereby achieving a desired biological outcome of reducing loss of the at least one produce item due to the first fungus. In one non-limiting implementation, the edible spray or coating composition comprising the carrier, at least one antimicrobial compound, and at least one immunostimulatory compound may create a synergistic effect of an increased reduction in loss of the at least one produce item compared to the loss of the at least one produce item upon which the carrier, at least one antimicrobial compound, and at least one immunostimulatory compound are applied individually to the at least one produce item. In another implementation, the edible spray or coating composition having a lower concentration of the antimicrobial compound and a lower concentration of the immunostimulatory compound may achieve the same desired biological result once applied to the at least one produce item as an edible spray or coating composition having a higher concentration of the antimicrobial compound and an edible spray or coating composition having a higher concentration of an immunostimulatory compound individually applied to the at least one produce item.

In other non-limiting implementations, the shelf-life extending agent may be an ethylene inhibitor selected from a group consisting of 1-alkene, 1-butene, 1-pentene, 1-hexene, 1-heptene, 1-octene, 1-nonene, 1-decene, 1-dodecene, 1-tetradecene, eugenol, limonene, 1-methylcyclopropene, linalool, myrcene, ocimene, pinene, camphene, linalyl acetate, dihydrotagetone, estragole, nerolidol, chavicol, 4-allylanisole and combinations thereof. The ethylene inhibitor refers to a compound that inhibits the signaling of an ethylene related pathway and/or production of ethylene in the at least one produce item by blocking an ethylene signal receptor in the at least one produce item or inhibiting the biosynthesis of ethylene by the at least one produce item. Ethylene is known as “the ripening hormone” and is a gaseous compound released by some produce items, which may cause the produce item to ripen. The concentration of the ethylene inhibitor in the edible spray or coating composition may be in a range of about 0.1% to about 20% by weight.

In one non-limiting implementation, the edible spray or coating composition may comprise the antimicrobial compound, which may suppress the growth and spread of a first fungus on a produce item and the ethylene inhibitor compound, which may absorb the block the signaling of an ethylene related pathway and/or inhibit the production and release of ethylene by the produced item. The edible spray or coating composition may be sprayed, coated, or otherwise applied on the surface of the produce item to achieve the desired biological outcome of reducing the degradation of the at least one produce item due to the first fungus and ethylene. The edible spray or coating composition comprising the antimicrobial compound and the ethylene inhibitor may create a synergistic effect of an increased extension of life of the at least one produce item compared to the extension of life of the at least one produce item when the antimicrobial compound and the ethylene inhibitor are applied to the surface of the at least one produce item individually.

In other non-limiting implementations, the shelf-life extending agent may be an antioxidant. The antioxidant may be chosen from a group consisting of vitamin A, vitamin C, vitamin E, thiols, tocopherol, catechins, anthocyanins, polyphenols, resveratrol, butylated hydroxytoluene (BHT), butylated hydroxyanisole (BHA), and combinations thereof. The concentration of the antioxidant in the edible spray or coating composition at may be in a range of about 0.1% to about 20% by weight.

In certain particular (but non-limiting) embodiments, the edible spray or coating composition contains two or more shelf-life extending agents, such as (but not limited to), three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21 or more, 22 or more, 23 or more 24 or more, 25 or more, 26 or more, 27 or more, 28 or more, 29 or more, 30 or more, 35 or more, 40 or more, 45 or more, or 50 or more shelf-life extending agents. When two or more shelf-life extending agents are present, the agents may be from the same class of compounds (i.e., antimicrobial compound, bio-control agent, immunostimulatory compound, ethylene inhibitor, antioxidant, etc.) or from a combination of classes of compounds.

The shelf-life extending agent(s) may be present in the edible spray or coating composition at any percentage of concentration that allows the composition to function as described or as otherwise contemplated herein. For example (but not by way of limitation), each shelf-life extending agent may be present in the composition at a percent concentration of about 0.001%, about 0.005%, about 0.01%, about 0.05%, about 0.1%, about 0.5%, about 1%, about 2%, about 3%, about 4%, about 5%, about 6%, about 7%, about 8%, about 9%, about 10%, about 15%, about 20%, about 25%, about 30%, or higher. In addition, the scope of the presently disclosure also includes the presence of each shelf-life extending agent in the composition at any percent concentration that falls within any range formed from the combination of two values listed above (for example, a range of from about 0.01% to about 30%, a range of from about 0.05% to about 25%, a range of from about 0.1% to about 20%, etc.).

The carrier or film-forming material of the edible spray or coating composition for extending the life of at least one produce item in the presently disclosed and/or claimed inventive concept may be chosen from a group consisting of an emulsifier, a protein, a wax, a polysaccharide, a gum, carbohydrate, and combinations thereof. The carrier or film-forming material may prevent the spoilage of the at least one produce item via the replacement or reinforcement of the surface of the produce item, by positioning the shelf-life extending agent on the surface of the at least one produce item, and the like. The carrier or film-forming material may serve to increase the shelf life of perishable good and/or may serve to reduce the spoilage of the at least one produce item.

In some non-limiting implementations, the carrier or film-forming material may be an emulsifier. The emulsifier may be chosen from a group consisting of glycerolipids, monoglycerides, diglycerides, fatty acid, fatty acid salts, fatty alcohol, lecithin, glycerol, sterol, and combinations thereof. The concentration of the emulsifier in the edible spray or coating composition may be in a range of about 0.1% to about 20% by weight. U.S. Patent Publication No. 20200383343 is herein incorporated by reference.

In some implementation, the carrier or film-forming material may be a protein. The protein may be chosen from a group consisting of silk protein, silk fibroin, collagen, gelatin, silk, gluten, zein, casein, keratin, soy protein, pea protein, sunflower protein, and combinations thereof. The concentration of the protein in the edible spray or coating composition may be in a range of about 0.5% to about 20% by weight. U.S. Patent Publication No. 20200178576 is herein incorporated by reference.

In other non-limiting implementations, the carrier or film-forming material may be a wax. The wax may be chosen from a group consisting of beeswax, lanolin, carnauba wax, candelilla wax, bayberry wax, soy wax, petroleum wax, paraffin wax, candle wax, and combinations thereof or an oil. In other non-limiting implementations, the carrier or film-forming material may be an oil. The oil may be chosen from a group consisting of canola oil, safflower oil, grapeseed oil, avocado oil, walnut oil, coconut oil, soybean oil, palm oil, hydrogenated oil, peanut oil, sesame oil, almond oil, paraffin oil, and combinations thereof. The concentration of the wax in the edible spray or coating composition at the time of application to the at least one produce item may be in a range of about 0.1% to about 10% by weight. The concentration of the oil in the edible spray or coating composition at the time of application to the at least one produce item may be in a range of about 40% to about 98%.

In other non-limiting implementations, the carrier or film-forming material may be a polysaccharide or a gum. The polysaccharide may be chosen from a group consisting cellulose, modified cellulose, pectin, chitosan, chitin, alginate, starch, modified starch, carrageenan, agar, shellac, hyaluronic acid, inulin, and combinations thereof. The gum may be chosen form a group consisting of xanthan gum, gum Arabic, guar gum, Locust bean gum, mastic, gellan gum, spruce gum, and combinations thereof. Gum Arabic is comprised of galactose, rhamnose, arabinose, and glucoronic acid. Gum Arabic may stabilize oils in a solvent having water. In one non-limiting implementation, about 10% of gum Arabic may be used in combination with at least one starch, maltodextrin, insulin, and essential oils extend the life of the at least one produce item.

In certain particular (but non-limiting) embodiments, the edible spray or coating composition contains two or more carrier or film-forming materials, such as (but not limited to), three or more, four or more, five or more, six or more, seven or more, eight or more, nine or more, ten or more, 11 or more, 12 or more, 13 or more, 14 or more, 15 or more, 16 or more, 17 or more, 18 or more, 19 or more, 20 or more, 21 or more, 22 or more, 23 or more 24 or more, 25 or more, 26 or more, 27 or more, 28 or more, 29 or more, 30 or more, 35 or more, 40 or more, 45 or more, or 50 or more carrier or film-forming materials. When two or more carrier or film-forming materials are present, the materials may be from the same class of compounds (i.e., emulsifier, protein, wax, polysaccharide, gum, carbohydrate, etc.) or from a combination of classes of compounds.

The carrier or film-forming material(s) may be present in the edible spray or coating composition at any percentage of concentration that allows the composition to function as described or as otherwise contemplated herein. For example (but not by way of limitation), each carrier or film-forming material may be present in the composition at a percent concentration of about 0.001%, about 0.005%, about 0.01%, about 0.05%, about 0.1%, about 0.5%, about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, about 80%, about 85%, about 90%, or higher. In addition, the scope of the presently disclosure also includes the presence of each carrier or film-forming material in the composition at any percent concentration that falls within any range formed from the combination of two values listed above (for example, a range of from about 0.01% to about 90%, a range of from about 0.05% to about 50%, a range of from about 0.1% to about 50%, a range of from about 0.1% to about 20%, etc.).

When present, the solvent of the edible spray composition for extending the life of at least one produce item in the presently disclosed and/or claimed inventive concept may be chosen from a group consisting of an alcohol, an oil, water, or combinations thereof. In some non-limiting implementations, water may be used in combination with at least one salt as the solvent. In some non-limiting implementations, the alcohol may be chosen from a group consisting of ethanol, glycerol, polyvinyl alcohol, isopropyl alcohol, and combinations thereof. In some non-limiting implementations, the oil may be chosen from a group consisting of canola oil, grapeseed oil, avocado oil, walnut oil, coconut oil, soybean oil, palm oil, hydrogenated oil, peanut oil, sesame oil, almond oil, paraffin oil, safflower oil, and combinations thereof.

In certain particular (but non-limiting) embodiments, the solvent contains two or more solvents, such as (but not limited to), three or more, four or more, five or more, six or more, seven or more, eight or more, nine or more, or ten or more solvents. When two or more solvents are present, the solvents may be from the same class of compounds (i.e., alcohol, an oil, water, etc.) or from a combination of classes of compounds.

The solvent(s) may be present in the edible spray or coating composition at any percentage of concentration that allows the composition to function as described or as otherwise contemplated herein. For example (but not by way of limitation), each solvent may be present in the composition at a percent concentration of about 0.001%, about 0.005%, about 0.01%, about 0.05%, about 0.1%, about 0.5%, about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or higher. In addition, the scope of the presently disclosure also includes the presence of each solvent in the composition at any percent concentration that falls within any range formed from the combination of two values listed above (for example, a range of from about 0.01% to about 95%, a range of from about 0.1% to about 59%, etc.).

Certain non-limiting embodiments of the present disclosure are directed to a method for applying the edible spray or coating composition onto at least one surface of the at least one produce item in order to protect the at least one produce item from degradation and decomposition (e.g., spoilage) and extend the life of the at least one produce item. The edible spray or coating composition may be applied to at least a portion of at least one surface of the at least one produce item by any method known in the art or otherwise contemplated herein, such as (but not limited to) spraying, coating, dipping, pouring, brushing, misting, or the like. The method for applying the edible spray or coating onto at least one surface of the at least one produce item forms a protective coating on the surface of the at least one produce item. The method of applying the edible spray or coating composition onto at least one surface of the at least one produce item may also include (for example, but not by way of limitation) forming a fog, the fog being formed of droplets of the mixture that have an average diameter of about 100 microns or less, and allowing the fog to contact the surface of the at least one produce item so that a portion of the mixture accumulates on at least a portion of the surface of the at least one produce item. The solvent of the edible spray or coating composition may partially be removed from the surface by evaporation or forced convection. The edible spray or coating composition remaining on the surface of the at least one produce item forms the protective coating. The protective coating extends the life of the at least one produce item by protecting the at least one produce item from mechanical damage, biotic or abiotic stressors such as mass or moisture loss, oxidation, mold, fungi, and infestation.

In some non-limiting implementations, the method of preserving the at least one produce item may include the sanitizing of the at least one produce item. The method for sanitizing and preserving the at least one produce item may include providing a sanitizing solution comprising the edible spray or coating composition and a sanitizing agent. The sanitizing solution is configured to solidify and form the protective coating. The sanitizing solution may be applied to the surface of the perishable good for a sufficient amount of time to sanitize the at least one produce item. At least a portion of the solvent of the edible spray or coating composition and the sanitizing agent are removed from the surface of the produce item via evaporation or forced convection. The remaining sanitizing solution on the surface of the produce item may form the protective coating. The sanitizing agent may be (for example, but not by way of limitation) a natural surfactant derived from an egg or plant product. In some non-limiting implementations, the sanitizing agent may be chosen from a group consisting of ethanol, acetone, isopropanol, and/or ethyl acetate (e.g., dissolved in water). In some non-limiting implementations, the sanitizing agent contains at least 30% ethanol (e.g., at least 30%, at least 35%, at least 40%, at least 45%, at least 50%, at least 55%, at least 60%, at least 65%, at least 70%, at least 75%, at least 80%, at least 85%, at least 90%, or at least 95%). In some non-limiting implementations, the sanitizing agent may be positioned between the surface of the produce item and the edible spray or coating composition acting as a connecting agent between the edible spray or coating composition and the surface of the produce item. The sanitizing agent may also act as a delaminating agent preventing the coating agent from fracturing into layers.

In some non-limiting implementations of any of the above-aspects, the solvent may comprise water. In some non-limiting implementations, the sanitizing agent may be an alcohol. The sanitizing agent may comprise ethanol, acetone, isopropanol, or ethyl acetate. (e.g., dissolved in water). In some non-limiting implementations, the sanitizing agent contains at least 30% ethanol (e.g., at least 30%, at least 35%, at least 40%, at least 45%, at least 50%, at least 55%, at least 60%, at least 65%, at least 70%, at least 75%, at least 80%, at least 85%, at least 90%, or at least 95%). In some non-limiting implementations, sanitizing the edible substrate may prevent fungal growth on the edible substrate.

### EXAMPLES

Examples are provided hereinbelow. However, the present disclosure is to be understood to not be limited in its application to the specific experimentation, results, and laboratory procedures disclosed herein after. Rather, the Examples are simply provided as one of various embodiments and are meant to be exemplary, not exhaustive.

### Example 1

In this Example, the edible spray or coating composition was applied to a first group of produce items, in this case strawberries, via the dip coating method. A second group of produce items were not coated in the edible spray or coating composition and remained a control group.

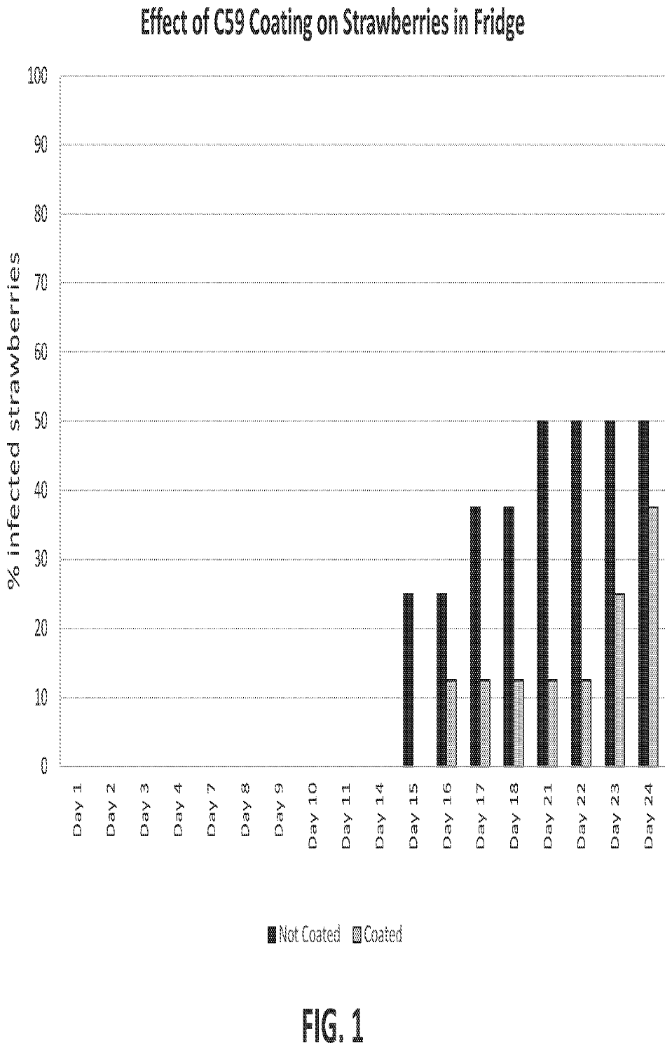

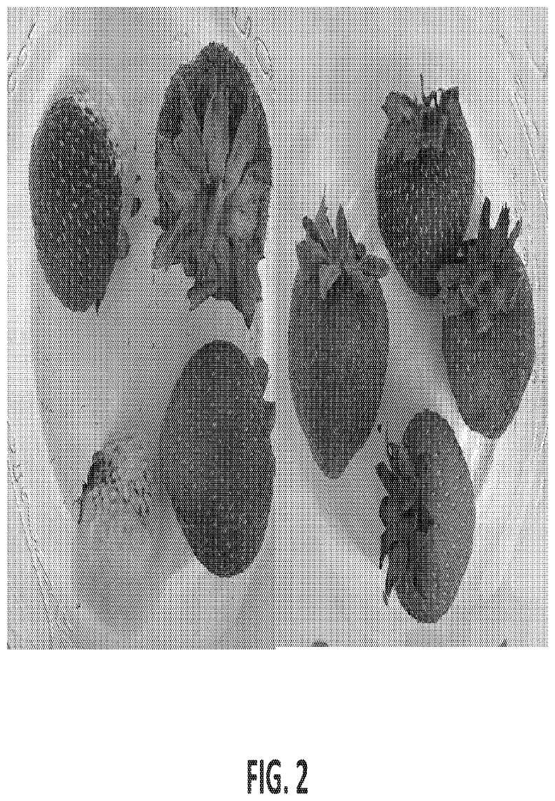

The first group and second group of produce items were stored in a standard refrigerator apparatus between 2-6° C. for four weeks. The number of produce items infected with mold were measured each day. The edible spray or coating composition included an essential oil compound, water, and a carrier including a mixture of natural oils, fatty acids salts, and glycerol. A method of forming the carrier combined the mixture of natural oils with an alkaline agent until the carrier was in a homogeneous, solid state. The alkaline agent was chosen from a group consisting of sodium hydroxide, potassium hydroxide, sodium bicarbonate, dipotassium phosphate, and any combinations thereof. The mixture of natural oils was chosen from a group consisting of canola oil, palm oil, coconut oil, sesame oil, grapeseed oil, and combinations thereof. In the experiment, the alkaline was sodium hydroxide and the natural oil used was canola oil. Upon the combination of the sodium hydroxide and the canola oil, a saponification reaction occurs, in which the triglycerides of the canola oil react with the sodium hydroxide to form glycerol and fatty acid salts. Due to the use of the canola oil, the fatty acid salts comprised sodium oleate and sodium linoleate. The carrier may have a pH ranging from 14 to 7. In the experiment, the carrier had a pH below 10. The carrier was added to the solvent comprising 0.3 w % carrier and 99.7 w % water to form a viscous liquid or gel. No additives were added into the mixture to adjust the viscosity. However, in some non-limiting implementations, natural additives may be added into the edible spray or coating composition to adjust the viscosity of the composition. The natural additives may be (for example, but not by way of limitation) alginate, chitosan, shellac, gum Arabic, carrageenan, cellulose, starch, at least one essential oil, coconut oil, soy oil, at least one antioxidant, tocopherol, salts, and a combination thereof. The next step was adding the shelf-life extending agent to the carrier and solvent composition. In this example, cuminaldehyde was added to achieve a final concentration of 4 w %. The next step of the experiment was to apply a brief anneal to 30° C. and to apply sonification to form the edible spray or coating composition. The method of dipping applied the edible spray or coating composition to the first group of at least one produce item. The first group of the at least one produce item was dipped for about ten seconds and then stored in a container. As seen in FIGS. 1 and 2, the first group of at least one produce item had a much lower fungal infection rate than the second group of the at least one produce item.

### Example 2

This Example provides various non-limiting embodiments of formulations of edible spray or coating compositions constructed in accordance with the present disclosure.

The following are non-limiting examples of the edible spray or coating composition comprising at least one shelf-life extending agent, at least one carrier or film-forming material, and at least one solvent, wherein the at least one shelf-life extending agent comprises at least one essential oil, the at least one carrier or film-forming material comprises at least one emulsifier, and the solvent or thinning agent comprises water:
1) thymol (0.5-20%), (R)-limonene (0.5-20%), mixture of fatty acids (0.5-20%), and water (40-98.5%);
2) cuminal (0.5-20%), mixture of glycerolipids (0.5-20%), oil (0.5-20%), and water (40-98.5%); and
3) cuminal (0.5-20%), mixture of fatty acids (0.5-20%), glycerol (0.1-20%), water (40-98.5%), and oil (0-50%).

The following are non-limiting examples of the edible spray or coating composition comprising at least one shelf-life extending agent, at least one carrier or film-forming material, and at least one solvent, wherein the at least one shelf-life extending agent comprises an essential oil, the at least one carrier or film-forming material comprise sat least one protein, and the at least one solvent or thinning agent comprises water:
1) octanal (0.5-20%), jasmonic acid (0.05-10%), silk fibroin (0.5-50%), and water (20-98%);
2) borneol (0.5-20%), zein (0.5-50%), alcohol (0-98%), and water (0-98%).

The following are non-limiting examples of the edible spray or coating composition comprising at least one shelf-life extending agent, and at least one carrier or film-forming material, wherein the at least one shelf-life extending agent comprises an essential oil, and the at least one carrier or film-forming material is chosen from a group consisting of wax, oil, and combinations thereof where the oil may further serve as a solvent):
1) citral (0.5-20%), 1-octene (0.5-20%), wax (0.1-10%), and oil (50-98%)
2) nonanal (0.5-20%), (S)-citronellal (0.5-20%), wax (0.1-10%), and oil (50-98%).

The following are non-limiting examples of the edible spray or coating composition comprising at least one shelf-life extending agent, and at least one carrier or film-forming material, wherein the at least one shelf-life extending agent comprises an essential oil, and the at least one carrier or film-forming material comprises carbohydrate and/or gum, and the at least one solvent or thinning agent includes water:
1) 2-(E)-hexanal (0.1-20%), chitosan (0.1-50%), and water (30-98%);
2) 2, 4-(E),(Z)-nonadienal (0.5-20%), tocopherol (0.1-20%), cellulose (20 -60%), and water (20-98%).

The following are non-limiting examples of the edible spray or coating composition comprising at least one shelf-life extending agent, at least one carrier or film-forming material, and at least one solvent, wherein the at least one shelf-life extending agent comprises an essential oil, the at least one carrier or film-forming material comprises carbohydrate, gum, wax, oil, protein, and/or emulsifier, and the at least one solvent or thinning agent comprises water or oil:
1) perillal (0.5-20%), wax (0.1-20%), fatty alcohols (0.1-10%), glycerol (0.1-20%), and oil (40-98%);
2) thymol (0.5-20%), gum Arabic (0.1-20%), mixture of fatty acids (0.1-20%), and water (0.5-98%).

Thus, in accordance with the present disclosure, there have been provided compositions, as well as methods of producing and using same, which fully satisfy the objectives and advantages set forth hereinabove. Although the present disclosure has been described in conjunction with the specific drawings, experimentation, results, and language set forth hereinabove, it is evident that many alternatives, modifications, and variations will be apparent to those skilled in the art. Accordingly, it is intended to embrace all such alternatives, modifications, and variations that fall within the spirit and broad scope of the present disclosure.

The following is a number list of non-limiting illustrative implementations of the inventive concept disclosed herein. 1. An edible spray or coating composition for extending life of at least one produce item, wherein the edible spray or coating composition comprises a. at least one shelf-life extending agent, wherein the shelf-life extending agent is selected from a group consisting of an antimicrobial compound, a bio-control agent, an immunostimulatory compound, an ethylene inhibitor, an antioxidant, and combinations thereof; and b. at least one carrier or film-forming material, wherein the carrier or film-forming material is chosen from a group consisting of an emulsifier, a protein, a wax, a polysaccharide, a gum, carbohydrate, and combinations thereof.

2. The edible spray or coating composition of claim 1, wherein the antimicrobial compound comprises at least one essential oil selected from a group consisting of hexanal, hexenal, cuminal, cuninaldehyde, perillal, carvacrol, thymol, citral, citronellal, citronellol, menthol, cinnamal, terpinene-4-ol, terpineol, carvone, menthone, pulegone, eugenol, linalool, nerol, neral, geraniol, geranial, hexanol, hexenol, octanal, octanol, octenol, octenal, nonanol, nonanal, nonenol, nonenal, nonadienol, nonadienal, farnesol, limonene, pinene, myrcene, ocimene, terpinene, anethole, borneol, myrtenal, myrtenol, fenchol, piperonol, piperonal, pulegol, carveol, decanal, decanol, decenal, decenol, decadienol, decadienal, cymene, menthane, phellandrene, phellandral, camphene, camphor, fenchone, cuminol, o-anisal, p-anisal, raspberry ketone, ionone, damescenone, lilac aldehyde, fenchene, bornylene, perillol, piperitone, geranial, nerolidol, rhodinol, furanones, and combinations thereof.

3. The edible spray or coating compound of claim 1, wherein the antimicrobial compound comprises at least one compound selected from a group consisting of citric acid, citrate, sodium citrate, capsaicin, acetic acid, acetate, sorbic acid, benzoic acid, propionic acid, sulfite, sodium sulfite, sorbate, potassium sorbate, benzoate, sodium benzoate, propionate, calcium propionate, curcumin, coumarin, phenylalaine, vanillin, nootkatone, natamycin, and combinations thereof.

4. The edible spray or coating composition of claim 1, wherein the biocontrol agent is selected from a group consisting of Bacillus, Pseudomonas, Cryptococcus, Clonostachys, and combinations thereof.

5. The edible spray or coating composition of claim 1, wherein the immunostimulatory compound is selected from a group consisting of methyl jasmonate, methyl salicylate, methyl cinnamate, beta-aminobutyric acid (BABA), phytoanticipines, biochar, acibenzolar-S-methyl, thiamine, jasmonic acid, salicylic acid, cinnamic acid, phytoalexins, pinene, camphene, chitosan, and combinations thereof.

6. The edible spray or coating composition of claim 1, wherein the ethylene inhibitor is selected from a group consisting of 1-alkene, 1-butene, 1-pentene, 1-hexene, 1-heptene, 1-octene, 1-nonene, 1-decene, 1-dodecene, 1-tetradecene, eugenol, limonene, 1-methylcyclopropene, linalool, myrcene, ocimene, pinene, camphene, linalyl acetate, dihydrotagetone, estragole, nerolidol, chavicol, 4-allylanisole, and combinations thereof.

7. The edible spray or coating composition of claim 1, wherein the antioxidant is selected from a group consisting of vitamin A, vitamin C, vitamin E, thiols, tocopherol, catechins, anthocyanins, polyphenols, resveratrol, butylated hydroxytoluene (BHT), butylated hydroxyanisole (BHA), and combinations thereof.

8. The edible composition of claim 1, wherein the emulsifier is selected from a group consisting of glycerolipids, fatty acid, fatty acid salts, fatty alcohol, monoglyceride, diglyceride, lecithin, glycerol, sterol, and combinations thereof.

9. The edible composition of claim 1, wherein the protein is selected from a group consisting of silk protein, silk fibroin, collagen, gelatin, silk, gluten, zein, casein, keratin, soy protein, pea protein, sunflower protein, and combinations thereof.

10. The edible composition of claim 1, wherein the oil is selected form a group consisting of canola oil, safflower oil, grapeseed oil, avocado oil, walnut oil, coconut oil, soybean oil, palm oil, hydrogenated oil, peanut oil, sesame oil, almond oil, paraffin oil and combinations thereof.

11. The edible spray or coating composition of claim 1, wherein the wax is selected from a group consisting of beeswax, lanolin, carnauba wax, candelilla wax, bayberry wax, soy wax, petroleum wax, paraffin wax, candle wax, and combinations thereof.

12. The edible spray or coating composition of claim 1, wherein the polysaccharide is selected from a group consisting of cellulose, modified cellulose, pectin, chitosan, chitin, alginate, starch, modified starch, carrageenan, agar, shellac, hyaluronic acid, inulin, and combinations thereof.

13. The edible spray or coating composition of claim 1, wherein the gum is selected from a group consisting of xanthan gum, gum Arabic, guar gum, Locust bean gum, mastic, gellan gum, spruce gum, and combinations thereof.

14. The edible spray or coating composition of claim 1, further comprising at least one solvent or thinning agent, wherein the solvent or thinning agent is selected from a group consisting of an alcohol, an oil, water, and combinations thereof.

15. The edible spray or coating composition of claim 14, wherein the alcohol is selected from a group consisting of ethanol, glycerol, polyvinyl alcohol, isopropyl alcohol, and combinations thereof.

16. The edible spray or coating composition of claim 14, wherein the oil is selected from a group consisting of canola oil, grapeseed oil, avocado oil, walnut oil, coconut oil, soybean oil, palm oil, hydrogenated oil, peanut oil, sesame oil, almond oil, paraffin oil, safflower oil, and combinations thereof.

17. The edible spray or coating composition of claim 14, wherein the at least one solvent comprises water and at least one salt.

18. An edible spray or coating composition for extending life of at least one produce item, wherein the edible spray or coating composition, comprises a. at least one shelf-life extending agent, wherein the at least one shelf-life extending agent is selected from a group consisting of thymol, (R)-limonene, cuminal, octanal, jasmonic acid, borneol, citral, 1-octene, nonanal, (S)-citronellal, 2-(E)-hexanal, chitosan, 2, 4-(E),(Z)-nonadienal, tocopherol, perillal, and combinations thereof; b. at least one carrier or film-forming material, wherein the at least one carrier or film-forming material is selected from a group consisting of fatty acid, glycerolipid, glycerol, silk fibroin, zein, wax, chitosan, cellulose, fatty alcohol, gum Arabic, and combinations thereof; and c. at least one solvent or thinning agent, wherein the at least one solvent or thinning agent is selected from a group consisting of an alcohol, glycerol, an oil, and water.

19. The edible spray or coating composition of claim 18, wherein the at least one solvent or thinning agent comprises water and a least one salt.

20. An assembly, comprising at least one produce item; an edible composition sprayed or coated on at least a portion of at least one surface of the at least one produce item, wherein the edible composition applied to the at least one produce item is the edible spray or coating composition of any of claims 1-19.

21. A method for applying an edible spray or coating composition onto a surface of at least one produce item, comprising spraying at least a portion of at least one surface of the at least one produce item with the edible spray or coating composition of any of claims 1-19.

22. A method for applying an edible spray or coating composition onto a surface of at least one produce item, comprising coating at least a portion of at least one surface of the at least one produce item with the edible spray or coating composition of any of claims 1-19.

23. A method for applying an edible spray or coating composition onto a surface of at least one produce item, comprising dipping at least a portion of at least one surface of the at least one produce item with the edible spray or coating composition of any of claims 1-19.

24. A method for applying an edible spray or coating composition onto a surface of at least one produce item, comprising pouring onto at least a portion of at least one surface of the at least one produce item the edible spray or coating composition of any of claims 1-19.

25. A method of extending a shelf-life of at least one produce item, the method comprising applying the edible spray or coating composition of any one of claims 1-19 to at least a portion of at least one surface of the at least one produce item.

What is claimed is:

1. An edible spray or coating composition for extending life of at least one produce item, wherein the edible spray or coating composition comprises:
a) at least one shelf-life extending agent, wherein the shelf-life extending agent is selected from a group consisting of an antimicrobial compound, a bio-control agent, an immunostimulatory compound, an ethylene inhibitor, an antioxidant, and combinations thereof; and
b) at least one carrier or film-forming material, wherein the carrier or film-forming material is chosen from a group consisting of an emulsifier, a protein, an oil, a wax, a polysaccharide, a gum, carbohydrate, and combinations thereof.

2. The edible spray or coating composition of claim 1, wherein the antimicrobial compound comprises at least one essential oil selected from a group consisting of hexanal, hexenal, cuminal, perillal, carvacrol, thymol, citral, citronellal, citronellol, menthol, cinnamal, terpinene-4-ol, terpineol, carvone, menthone, pulegone, eugenol, linalool, nerol, neral, geraniol, geranial, hexanol, hexenol, octanal, octanol, octenol, octenal, nonanol, nonanal, nonenol, nonenal, nonadienol, nonadienal, farnesol, limonene, pinene, myrcene, ocimene, terpinene, anethole, borneol, myrtenal, myrtenol, fenchol, piperonol, piperonal, pulegol, carveol, decanal, decanol, decenal, decenol, decadienol, decadienal, cymene, menthane, phellandrene, phellandral, camphene, camphor, fenchone, cuminol, o-anisal, p-anisal, raspberry ketone, ionone, damescenone, lilac aldehyde, fenchene, bornylene, perillol, piperitone, geranial, nerolidol, rhodinol, furanones, and combinations thereof.

3. The edible spray or coating compound of claim 1, wherein the antimicrobial compound comprises at least one compound selected from a group consisting of citric acid, citrate, sodium citrate, capsaicin, acetic acid, acetate, sorbic acid, benzoic acid, propionic acid, sulfite, sodium sulfite, sorbate, potassium sorbate, benzoate, sodium benzoate, propionate, calcium propionate, curcumin, coumarin, phenylalaine, vanillin, nootkatone, natamycin, and combinations thereof.

4. The edible spray or coating composition of claim 1, wherein the biocontrol agent is selected from a group consisting of Bacillus, Pseudomonas, Cryptococcus, Clonostachys, and combinations thereof.

5. The edible spray or coating composition of claim 1, wherein the immunostimulatory compound is selected from a group consisting of methyl jasmonate, methyl salicylate, methyl cinnamate, beta-aminobutyric acid (BABA), phytoanticipines, biochar, acibenzolar-S-methyl, thiamine, jasmonic acid, salicylic acid, cinnamic acid, phytoalexins, pinene, chitosan, and combinations thereof.

6. The edible spray or coating composition of claim 1, wherein the ethylene inhibitor is selected from a group consisting of 1-alkene, 1-butene, 1-pentene, 1-hexene, 1-heptene, 1-octene, 1-nonene, 1-decene, 1-dodecene, 1-tetradecene, eugenol, limonene, 1-methylcyclopropene, linalool, myrcene, ocimene, pinene, camphene, linalyl acetate, dihydrotagetone, estragole, nerolidol, chavicol, 4-allylanisole, and combinations thereof.

7. The edible spray or coating composition of claim 1, wherein the antioxidant is selected from a group consisting of vitamin A, vitamin C, vitamin E, thiols, tocopherol, catechins, anthocyanins, polyphenols, resveratrol, butylated hydroxytoluene (BHT), butylated hydroxyanisole (BHA), and combinations thereof.

8. The edible composition of claim 1, wherein the emulsifier is selected from a group consisting of glycerolipids, fatty acid, fatty acid salt, fatty alcohol, monoglyceride, diglyceride, lecithin, glycerol, sterol, and combinations thereof.

9. The edible composition of claim 1, wherein the protein is selected from a group consisting of silk protein, silk fibroin, collagen, gelatin, silk, gluten, zein, casein, keratin, soy protein, pea protein, sunflower protein, and combinations thereof.

10. The edible composition of claim 1, wherein the oil is selected form a group consisting of canola oil, safflower oil, grapeseed oil, avocado oil, walnut oil, coconut oil, soybean oil, palm oil, hydrogenated oil, peanut oil, sesame oil, almond oil, paraffin oil, and combinations thereof.

11. The edible spray or coating composition of claim 1, wherein the wax is selected from a group consisting of beeswax, lanolin, carnauba wax, candelilla wax, bayberry wax, soy wax, petroleum wax, paraffin wax, candle wax, and combinations thereof.

12. The edible spray or coating composition of claim 1, wherein the polysaccharide is selected from a group consisting of cellulose, modified cellulose, pectin, chitosan, chitin, alginate, starch, modified starch, carrageenan, agar, shellac, hyaluronic acid, inulin, and combinations thereof.

13. The edible spray or coating composition of claim 1, wherein the gum is selected from a group consisting of xanthan gum, gum Arabic, guar gum, Locust bean gum, mastic, gellan gum, spruce gum, and combinations thereof.

14. The edible spray or coating composition of claim 1, further comprising at least one solvent or thinning agent, wherein the solvent or thinning agent is selected from a group consisting of an alcohol, an oil, water, and combinations thereof.

15. The edible spray or coating composition of claim 14, wherein the alcohol is selected from a group consisting of ethanol, glycerol, polyvinyl alcohol, isopropyl alcohol, and combinations thereof.

16. The edible spray or coating composition of claim 14, wherein the oil is selected from a group consisting of canola oil, grapeseed oil, avocado oil, walnut oil, coconut oil, soybean oil, palm oil, hydrogenated oil, peanut oil, sesame oil, almond oil, paraffin oil, safflower oil, and combinations thereof.

17. The edible spray or coating composition of claim 14, wherein the at least one solvent comprises water and at least one salt.

18. An edible spray or coating composition for extending life of at least one produce item, wherein the edible spray or coating composition, comprises:
a. at least one shelf-life extending agent, wherein the at least one shelf-life extending agent is selected from a group consisting of thymol, (R)-limonene, cuminal, octanal, jasmonic acid, borneol, citral, 1-octene, nonanal, (S)-citronellal, 2-(E)-hexanal, chitosan, 2, 4-(E),(Z)-nonadienal, tocopherol, perillal, and combinations thereof;
b. at least one carrier or film-forming material, wherein the at least one carrier or film-forming material is selected from a group consisting of fatty acid, glycerolipid, glycerol, silk fibroin, zein, wax, chitosan, cellulose, fatty alcohol, gum Arabic, and combinations thereof; and
c. at least one solvent or thinning agent, wherein the at least one solvent or thinning agent is selected from a group consisting of an alcohol, glycerol, an oil, and water.

19. The edible spray or coating composition of claim 18, wherein the at least one solvent or thinning agent comprises water and a least one salt.

20. An assembly, comprising:
at least one produce item;
an edible composition sprayed or coated on at least a portion of at least one surface of the
at least one produce item, wherein the edible composition applied to the at least one produce item is the edible spray or coating composition of any of claims 1-19.

21. A method for applying an edible spray or coating composition onto a surface of at least one produce item, comprising:
spraying at least a portion of at least one surface of the at least one produce item with the edible spray or coating composition of any of claims 1-19.

22. A method for applying an edible spray or coating composition onto a surface of at least one produce item, comprising:
coating at least a portion of at least one surface of the at least one produce item with the edible spray or coating composition of any of claims 1-19.

23. A method for applying an edible spray or coating composition onto a surface of at least one produce item, comprising:
dipping at least a portion of at least one surface of the at least one produce item with the edible spray or coating composition of any of claims 1-19.

24. A method for applying an edible spray or coating composition onto a surface of at least one produce item, comprising:
pouring onto at least a portion of at least one surface of the at least one produce item the edible spray or coating composition of any of claims 1-19.

25. A method of extending a shelf-life of at least one produce item, the method comprising:
applying the edible spray or coating composition of any one of claims 1-19 to at least a portion of at least one surface of the at least one produce item.
